(19) United States
(12) Patent Application Publication
(10) Pub. No.: US 2022/0335075 A1
(43) Pub. Date: Oct. 20, 2022

(54) FINDING EXPRESSIONS IN TEXTS

(71) Applicant: International Business Machines Corporation, Armonk, NY (US)

(72) Inventor: Daisuke Takuma, Toshima-ku (JP)

(21) Appl. No.: 17/230,123

(22) Filed: Apr. 14, 2021

(51) Int. Cl. G06F 16/34; G06F 3/0484; G06F 3/0481

(52) U.S. Cl. CPC G06F 16/345; G06F 3/04842; G06F 3/04812

(57) ABSTRACT

A technique for presenting a text is disclosed. In the technique, a target text is obtained and a difference summary between the target text and a set of similar texts similar to the target text is prepared. The difference summary includes one or more variable text parts in the target text each varied in at least one text in the set of similar texts and a statistic of varying of each variable text part over the set of similar texts. The one or more variable text parts are marked in the target text based on the statistic of each variable text part. The target text is shown with the one or more variable text parts marked.

### BACKGROUND

The present disclosure relates generally to document processing systems and more particularly, but not exclusively, to presenting a text and text mining.

In organizations such as governments and companies, one often utilizes a template by copying and pasting text parts from the template followed by replacing specific expressions in the template. Conversely, in particular fields, there are many texts that are very similar.

For instance, each local government has enacted ordinances and regulations that are different but have something in common among multiple local governments. When drafting or revising the ordinances and regulations, the local government officials would want to know variable text parts of legal statements and their alternative expressions or variations that are used frequently and/or in other local government. Generally, in such the case, the variable text parts would significantly vary in its length. Also note that regardless of the scale of the local government area the volume of the required regulations as well as workload for maintenance often does not different so much.

### SUMMARY

According to an embodiment of the present invention, a computer-implemented method for presenting a text is provided. The method includes obtaining a target text. The method also includes preparing a difference summary between the target text and a set of similar texts similar to the target text. The difference summary includes one or more variable text parts in the target text each varied in at least one text in the set of similar texts and a statistic of varying of each variable text part over the set of similar texts. The method further includes marking the one or more variable text parts in the target text based on the statistic of each variable text part. The method includes further showing the target text with the one or more variable text parts marked.

According to other embodiment of the present invention, a computer-implemented method for text mining is provided. The method include selecting a target text in a text collection. The method further include finding a set of similar texts similar to the target text from the text collection. The method also include computing an alignment and a difference between the target text and each similar text in the set of similar texts. The method further include computing a statistic of each difference over the text collection. Further the method includes enumerating a plurality of variable text parts each included in at least one text and varied in at least one other similar text in the text collection based on the statistic of each difference.

According to another embodiment of the present invention, there is provided a computer system. The computer system comprises a processing unit; and a memory coupled to the processing unit and storing instructions thereon. The instructions, when executed by the processing unit, perform acts of the computer-implemented method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the computer-implemented method according to the embodiment of the present invention.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 shows a schematic of a document presentation system according to an exemplary embodiment of the present invention;

FIG. 2 shows a flowchart of a process for presenting a target text with a difference summary according to an exemplary embodiment of the present invention;

FIGS. 3A and 3B show flowcharts of processes for presenting summary information of deletions and insertions according to an exemplary embodiment of the present invention;

FIG. 4 illustrates a schematic way of computing alignments and differences between two sentences according to one or more embodiments of the present invention;

FIGS. 5A-5B and FIGS. 6A-6B show schematics of data structures storing a difference summary according to an exemplary embodiment of the present invention;

FIG. 7 depicts graphical user interfaces for presenting a text with summary information of deletions and insertions according to an exemplary embodiment of the present invention;

FIG. 8 shows a schematic of a text mining system according to an exemplary embodiment of the present invention;

FIG. 9 shows a flowchart of a process for text mining to extract variable text parts in a text according to an exemplary embodiment of the present invention;

FIG. 10 shows a flowchart of a sub-process for text mining to extract variable text parts in a text according to an exemplary embodiment of the present invention;

FIG. 11 shows a flowchart of a process for obtaining alternative expressions for a seed expression according to an exemplary embodiment of the present invention;

FIG. 12 and FIG. 13 show results of extracting alternative expressions for particular seed expressions according to an exemplary embodiment of the present invention; and

FIG. 14 depicts a schematic of a computer system according to one or more embodiments of the present invention.

### DETAILED DESCRIPTION

Hereinafter, the present invention will be described with respect to particular embodiments, but it will be understood by those skilled in the art that the embodiments described below are mentioned only by way of examples and are not intended to limit the scope of the present invention.

One or more embodiments according to the present invention are directed to computer-implemented methods, computer systems and computer program products for presenting a target text, which may be written in a natural language, with summary information relating to variable text parts in the target text.

In one or more embodiments, the computer-implemented method includes at least one of obtaining a target text (e.g., ‘tax rate specified by the mayor’); preparing a difference summary between the target text and a set of similar texts (e.g., ‘tax rate necessary to support XXX’, ‘tax rate specified by Article X’, etc.) to the target text, marking one or more variable text parts (e.g., ‘specified by the mayor’ and ‘the mayor’) in the target text based on a statistic of varying of each variable text part (e.g., ‘specified by the mayor’ is deleted 1 time and ‘the mayor’ is deleted 3 times); and showing (i.e., presenting) the target text with the one or more variable text parts marked. The difference summary may include one or more variable text parts in the target text and the statistic of varying of each variable text part over the set of similar texts. The variable text part may be a text part (e.g., a word, words, a word boundary) that is included in the target text but varied (e.g., deleted or having an insertion) in at least one text in the set of similar texts. The varying of each variable text part may include a change that the text part included in the target text (e.g., ‘specified by the mayor’) is deleted in at least one similar text and a change that a text that is not included in the target text (e.g., ‘necessary to support XXX’) is inserted at a position corresponding to the variable text part (e.g., word boundary) in at least one similar text.

In one or more embodiments, the difference summary is computed by performing at least one of finding a plurality of texts similar to the target text as the set of similar texts; computing an alignment and a difference between the target text and each similar text in the set of similar texts (e.g., ‘tax rate [specified by the mayor](necessary to support XXX)’, ‘tax rate specified by [the mayor](Article x)’ where [ ] denote a deletion and ( ) be an insertion) by calculating a cost of modifying between the target text and each similar text by deletion and/or insertion; and counting the occurrence of string of each difference in the target text (e.g., ‘specified by the mayor’ is deleted 1 time). In a particular embodiment, modifying between the target text and each similar text does not take ‘replacement’ operation into account.

In one or more embodiments, the one or more variable text parts include a deletion part (e.g., ‘specified by the mayor’) and an insertion position (e.g., a word boundary between ‘rate’ and ‘specified’). Also, the statistic of varying of each variable text part includes a deletion frequency of each deletion part or an insertion frequency relating to (starting or ending at) each insertion position. Marking the one or more variable text parts in the target text includes marking a text range related to one or more deletion parts in the target text in a first manner (e.g., changing a background color or color depth) based on a deletion frequency of the one or more deletion parts; and marking a boundary (e.g., a word boundary) at the insertion position in the target text in a second manner (e.g., inserting a number, a symbol, etc.) different from the first manner based on the insertion frequency relating to the insertion position. In a particular embodiment, each of the first manner and the second manner may be selected from a group consisting of changing a text color, changing a background color of a text, changing a text size, changing text style, changing text-decoration, and inserting an annotation.

In one or more embodiments, the method further includes at least one of showing one or more deletion parts containing a term with a deletion frequency of each of the one or more deletion parts (e.g., by a popup dialog box) in response to choosing the term (e.g., clicking, tapping) in the target text; and showing a detail of an insertion related to an insertion position (e.g., by a popup dialog box) in response to choosing a boundary (e.g., clicking, tapping) in the target text. In a particular embodiment, the difference summary further includes a set of insertion parts (e.g., ‘necessary to support XXX’), for each insertion position, included in at least one text in the set of similar texts and an usage frequency of each insertion part over the set of similar texts (e.g., ‘necessary to support XXX’ is inserted 2 times). Showing the detail includes showing one or more insertion parts related to the boundary with the usage frequency of each of the one or more insertion parts.

One or more embodiments according to the present invention are also directed to computer-implemented methods, computer systems and computer program products for text mining, which may be mining a frequently-occurring expression in a text written in a natural language.

In one or more embodiments, the computer-implemented method includes at least one of selecting a target text (e.g., ‘tax rate specified by the mayor’) in a text collection; finding a set of similar texts (e.g., ‘tax rate necessary to support XXX’, ‘tax rate specified by Article X’, etc.) to the target text from the text collection; computing an alignment and a difference between the target text and each similar text in the set of similar texts (e.g., ‘tax rate [specified by the mayor](necessary to support XXX)’, ‘tax rate specified by [the mayor](Article X)’ where H denote a deletion and ( ) be an insertion); computing a statistic of each difference over the text collection; and enumerating a plurality of variable text parts (e.g., ‘specified by the mayor’, and ‘the mayor’) based on the statistic of each difference. The variable text part may be a text part (e.g., a word, words,) included in at least one text and varied (e.g., deleted) in at least one other similar text in the text collection. The alignment and the difference may be computed by calculating a cost of modifying between the target text and each similar text by deletion and/or insertion operations. Varying of each variable text part may include a change that the text part (e.g., ‘specified by the mayor’) in the target text is deleted in at least one similar text.

In a further particular embodiment, selecting the target text, finding the set of similar texts, computing the alignment and the difference and computing the statistic are repeatedly performed for each text in at least a part of the text collection.

In one or more embodiments, the method further includes at least one of tokenizing an example text (e.g., a text in the collection) into a sequence of linguistic units (e.g., term sequence); replacing an instance of each variable text part in the sequence with a pseudo-unit (e.g., pseudo-word) representing a corresponding one of the variable text parts; and learning an embedding production model by using the sequence replaced. The embedding production model is configured to output a vector representing an input in response to the input. Note that the linguistic unit may preferable be a word, however, the linguistic unit may be a character in another embodiment.

In one or more embodiments, the method further include at least one of receiving a seed expression (e.g., ‘by the mayor’); and finding one or more alternative expressions (e.g., ‘by the chairperson’, ‘by the town mayor’, . . . ) of the seed expression by using the embedding production model.

In one or more embodiments, computing the statistic includes at least one of counting occurrence of each deletion part that is included in the target text and deleted in at least one text in the set of similar texts and the statistic includes a deletion frequency of each deletion part.

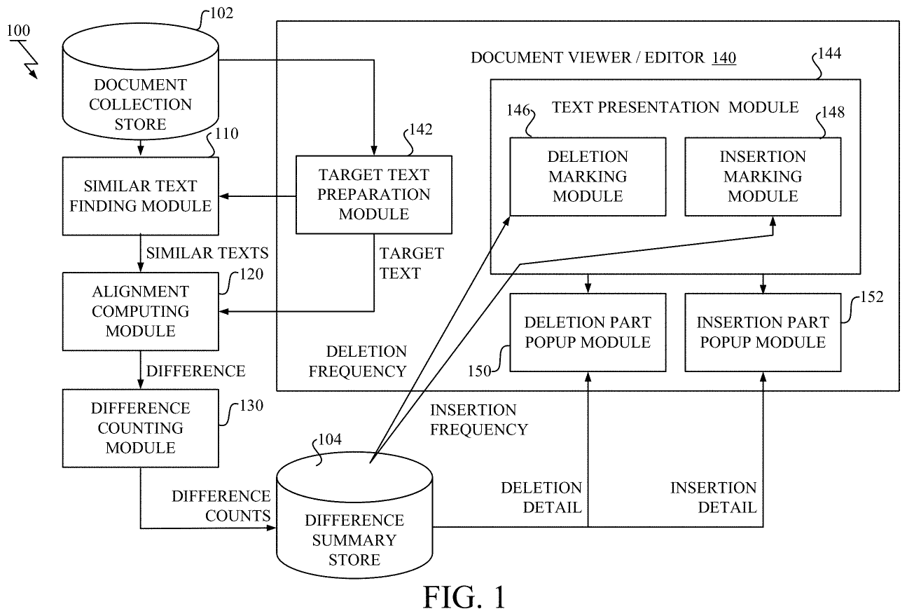

Herein below, referring to a series of FIG. 1 through FIG. 7, a computer-implemented method, a computer system and a computer program product for presenting a target text, which may be written in a natural language, with summary information relating to variable text parts according to an exemplary embodiment will be described.

With reference to FIG. 1, a schematic of a document presentation system according to an exemplary embodiment of the present invention is described. As shown in FIG. 1, the document presentation system 100 may include a document collection store 102, a similar text finding module 110, an alignment computing module 120; a difference counting module 130, a difference summary store 104, and a document viewer/editor 140 that includes a target text preparation module 142 and a text presentation module 144.

The document viewer/editor 140 are configured to present a document to allow viewing and/or editing of the document. The document may be presented by displaying a part or whole of the document on a display devices such as an LCD (liquid crystal display) display, an OLED (Organic Light Emitting Diode) display, an electronic paper, etc., to which processing circuitry of a computer system is operatively coupled.

The document to be presented by the document viewer/editor 140 may include a set of texts in a variety of granularity, which may include a whole document, a chapter, a section, a paragraph, a sentences and a clause that are a concatenation of words or characters. Note that in the described embodiment, one text of interest in the document presented by the document viewer/editor 140 is referred to as a ‘target text’ and the processing will be described assuming that the text of interest is processed. Thus, the entire processing to the document may include the processing for each text in the document.

In organizations such as governments and companies, one often utilizes a template by copying and pasting a certain text parts from the template followed by replacing limited portion in the templates. For instance, each local government has enacted ordinances and regulations that are different but have something in common among multiple local governments. For other instance, rules of employment may be defined for each individual company and such rules generally have company-specific parts as well as common parts. Furthermore, a business operation is often based on a document written in a natural language such as Microsoft Word documents, mails, or VARCHAR columns. Even in such cases, the documents often have patterns due to using templates.

The document viewer/editor 140 provides functionality that meets a request of a person who wants to know a variable text part of the document and their alternative expressions or variations that are used frequently and/or by other, when viewing or editing of the document.

The document collection store 102 is configured to store a collection of documents. The one document stored in the document collection store 102 may be designated to show in the document viewer/editor 140. The collection may include any kind of text data, including laws, ordinances, regulations, rules, to name but a few. The collection may also include any document files, mails, to name but a few. In a particular example, the document collection store 102 stores sets of ordinances of particular types (e.g., Personal Information Protection Ordinance) of a plurality of local governments. The document collection store 102 is provided by any internal or external storage (e.g., memory, persistence storage) in a computer system.

The target text preparation module 142 in the document viewer/editor 140 is configured to prepare, obtain, acquire or get a target text in the document to show the contents of the document in the document viewer/editor 140 for viewing or editing.

The similar text finding module 110, the alignment computing module 120 and the difference counting module 130 may run in the background of the document viewer/editor 140 and may be configured to prepare a difference summary in relation to the target text, which provides information about variable text parts and their alternative expressions or variations.

The similar text finding module 110 is configured to find a plurality of texts similar to the target text as a set of similar texts. The alignment computing module 120 is configured to compute an alignment and a difference between the target text and each similar text in the set of similar texts. Computing the alignment and the difference may be done by calculating a cost of modifying between the target text and each similar text (more specifically, modification from the target text to each similar text) by deletion and/or insertion operations. Also note that the alignment computing module 120 computes one-to-many alignment between one target text and plural similar texts.

In a preferable embodiment, modifying between the target text and each similar text includes only inserting a text part and/or deleting a text part and does not include replacing a first text part with a second text part even though the combination of deletion and insertion would result in equivalent to the replacement. Hence, modifying between the target text and each similar text does not take ‘replacement’ operation into account.

In addition, in the described embodiment, the insertion and the deletion may be calculated in a word level. However, in other embodiment, the insertion and the deletion may be calculated in a character level.

Further note that similarity and alignment can be calculated between the target text and each similar text at a variety of levels, including, a document level, a chapter level, section level, a sentence level, an article level, etc., by using an appropriate natural language processing technique. For example, the process may include retrieving similar texts by section-wise similarity using section names with a low threshold, computing the section-wise alignment with a high threshold for correspondence, and computing the term-wise alignment only for the sections having corresponding sections. For the purpose of convenience, although the target text may be a whole document, a chapter, a section, a paragraph, a sentence, a clause, the target text is assumed to be a sentence and each similar text has a sentence that is aligned to the sentence of the target text at sentence level and has similar contents to the sentence of the target text.

In a particular embodiment, the alignment between the target text and each similar text may be taken by minimizing the cost of modifying between the target text and each similar text and storing merely an optimal alignment that minimizes the cost. However, in other embodiment, the alignment may be taken by minimizing the cost and storing the optimal alignment and one or more suboptimal alignment candidates around the optimal. When a plurality of alignment candidates having similar costs are obtained, the alignment computing module 120 may choose a combination of alignments having the same operations (the same insertion operations or the same deletion operations) in succession as long as possible.

Once the alignment is taken, a difference between the target text and each similar text may be identified as a deletion part and/or an insertion part. For instance, when the target text is ‘tax rate specified by the mayor’ and one similar text is ‘tax rate necessary to support XXX’, there is one aligned part ‘tax rate’, one deletion part ‘specified by the mayor’ and one insertion part ‘necessary to support XXX’. These alignment and difference are expressed as ‘tax rate [specified by the mayor](necessary to support XXX)’.

The difference counting module 130 is configured to count the occurrence of the string of each difference in the target text. The difference includes the deletion part and the insertion part, and relates to a variable text part that includes the deletion part and an insertion position (e.g., word boundary). The difference counting module 130 is configured to obtain a statistic of varying of each variable text part and store the obtained statistics. The statistic of varying of each variable text part includes a deletion frequency of the deletion part or an insertion frequency relating to the insertion position. Note that the term ‘frequency’ may be interpreted in a broad sense. The term ‘frequency’ has a plurality of meanings; one means the number of occurrences (i.e., count) and other means a rate of occurrence with respect to something, which may also be calculated from the number of occurrences.

By the target text preparation module 142 in the document viewer/editor 140 and modules 110, 120, 130 running in the background thereof, a difference summary between the target text and the set of similar texts is prepared and stored into the difference summary store 104. The difference summary store 104 is provided by any internal or external storage (e.g., memory, persistence storage) in a computer system.

The difference summary may include one or more variable text parts in the target text and a statistic of varying of each variable text part over the set of similar texts. The difference summary may also include a set of insertion parts for each insertion position and a usage frequency of each insertion part over the set of similar texts.

The document viewer/editor 140 is configured to present the target text with the summary information including the statistics that are aggregated from the set of similar texts so as to help us understand what expressions in the target text are replaced in other similar text, what expressions are used instead in other similar texts and how often these replacements occur.

With reference to FIG. 1, the text presentation module 144 may include a deletion marking module 146 and an insertion marking module 148. The document viewer/editor 140 may further include a deletion part popup module 150 and an insertion part popup module 152.

The deletion marking module 146 and the insertion marking module 148 are configured to mark variable text parts in the target text based on the statistic of each variable text part. The text presentation module 144 is configured to show the target text with the variable text parts marked.

More specifically, the deletion marking module 146 is configured to mark a text range related to one or more deletion parts in the target text in a first manner based on a deletion frequency of the one or more deletion parts related to the text range. The first manner may be selected from a group consisting of changing a text color, changing a text background color, inserting an annotation, changing a text size, changing text style, changing text-decoration. Note that the marking is performed in word level or character level. In a particular embodiment, the text range may have a particular background color whose color depth is changed according to a total deletion frequency of the one or more related deletion parts that involve the text range.

Since the text range may be related to a plurality of deletion parts, multiple text ranges included in one deletion part may differently marked. For instance, when there are two deletion parts sharing a part (e.g., the part ‘specified by the mayor’ and the part ‘the mayor’ shares a text part ‘the mayor’) the text range corresponding to the shared part ‘the mayor’ is marked according to the total count of the two deletion parts. Hence, the text range ‘specified by’ and the text range ‘the mayor’ may be marked differently (e.g., having different color depth).

The insertion marking module 148 is configured to mark a boundary at the insertion position in the target text in a second manner based on the insertion frequency relating to the insertion position. The second manner may also be selected from a group consisting of changing a text color, changing a text background color, inserting an annotation, changing a text size, changing text style, changing text-decoration and may be different from the first manner for marking the deletion part. In a particular embodiment, the boundary may have an insertion of a number corresponding to the insertion frequency with a symbol (e.g., [3]).

The deletion part popup module 150 is configured to, in response to choosing a term in the target text, show one or more deletion parts containing the chosen term with their deletion frequencies. Choosing the term includes clicking the term, tapping the term, double-clicking the term, pressing a key with a cursor on the term or combination thereof, to name but a few. The one or more deletion parts that contain the term may be shown by using a popup dialog box or other appropriate graphical interface. When the chosen term is included in two different deletion parts, statistics of two deletion parts are summarized in the dialog. For example, when there are two deletion parts sharing the same term (e.g., deletion part ‘[specified by the mayor]’ and deletion part ‘[the mayor]’ may share a term ‘mayor’) both the deletion counts of the two deletion parts are shown in the dialog box in response to choosing the shared term (e.g., term ‘mayor’).

The insertion part popup module 152 is configured to, in response to choosing a boundary in the target text, show a detail of an insertion related to the insertion position. Choosing the boundary includes clicking an inserted symbol at the boundary, tapping the inserted symbol, double-clicking the inserted symbol, pressing a key with a cursor on the inserted symbol or combination thereof, to name but a few. Showing the detail includes showing one or more insertion parts related to the boundary with the usage frequency of each insertion part.

In one or more embodiments, each of the modules 110, 120, 130, 140, 142, 144, 146, 148, 150, 152 shown in FIG. 1 may be implemented as a software module including program instructions and/or data structures in conjunction with hardware components such as a processor, a memory, etc.; as a hardware module including electronic circuitry; or as a combination thereof. These modules may be implemented on a single computer device such as a personal computer and a server machine or over a plurality of computer devices in a distributed manner such as a computer cluster of computer devices, client-server system, cloud computing system, edge computing system, etc.

In a particular embodiment, both of the representation logic (i.e., 140) and the background logic (e.g., 110-130) may be implemented on a client computer. In other particular embodiment, the representation logic (i.e., 140) may be implemented on a client computer the background logic (e.g., 110-130) may be implemented on one or more server computers.

The document collection store 102, the difference summary store 104 and a storage for storing intermediate result may be provided by using any internal or external storage device or medium, to which processing circuitry of a computer system implementing these modules is operatively coupled.

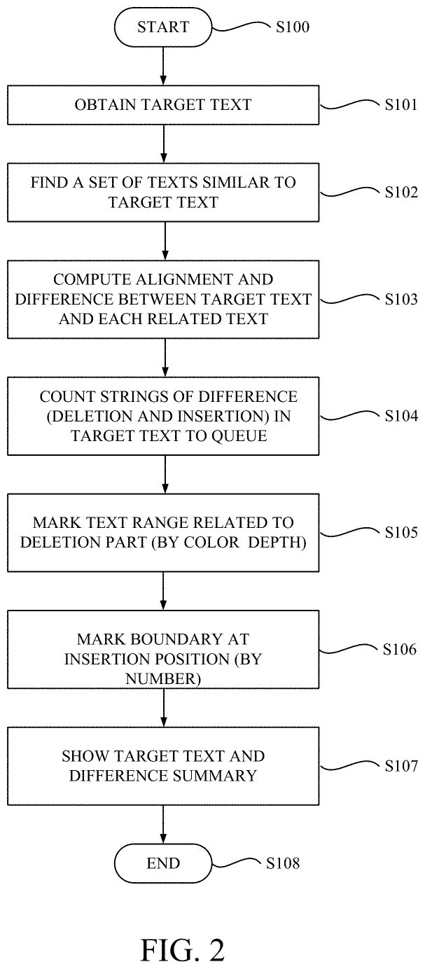

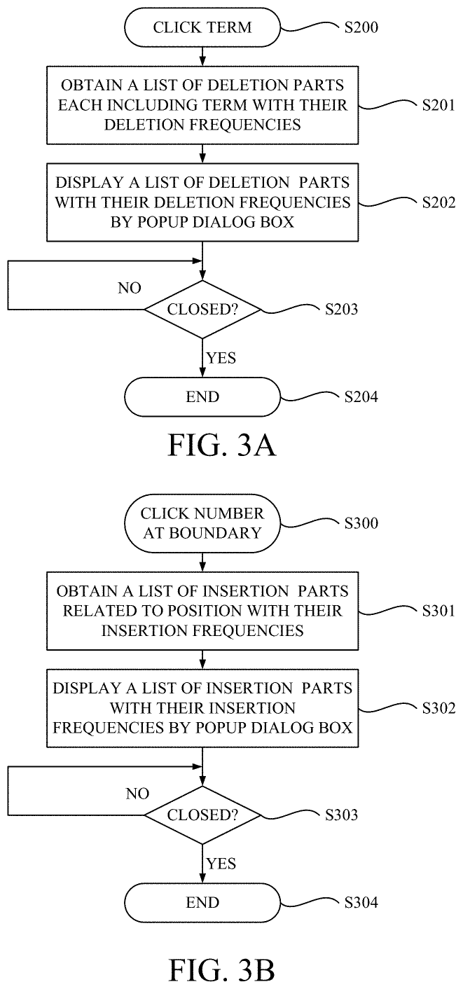

Hereinafter, with reference to FIG. 2 and FIGS. 3A-3B, a process for presenting a text with a difference summary according to an exemplary embodiment of the present invention is described. FIG. 2 shows a flowchart of the process for presenting a target text with a difference summary. FIGS. 3A and 3B show flowcharts of processes for presenting summary information of deletions and insertions, respectively. Note that the processes shown in FIG. 2, FIG. 3A and FIG. 3B may be performed by processing circuitry such as a processing unit of a computer system that implements at least one of aforementioned modules.

The process shown in FIG. 2 may begin at step S100 in response to receiving a request for presenting a designated document including a target text from an operator, for instance. However, the process may begin in response to any event, including an update of document, a trigger event, an implicit request, a timer, etc.

At step S101, the processing unit may prepare a target text in a document. At step 102, the processing unit may find a plurality of texts similar to the target text as a set of similar texts. At step S103, the processing unit may compute an alignment and a difference between the target text and each similar text in the set of similar texts by calculating a cost of modifying between the target text and each similar text by deletion and/or insertion operations.

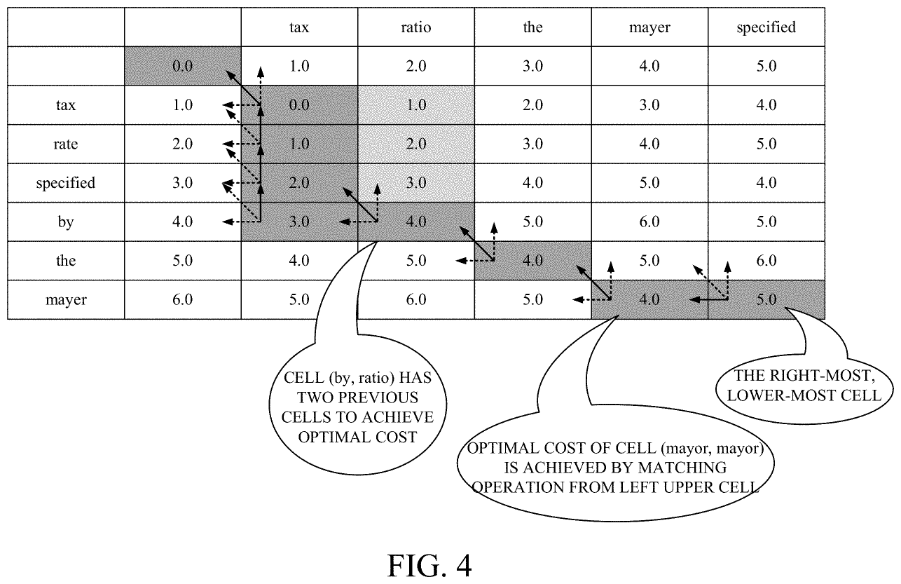

FIG. 4 illustrate a schematic of a way of computing alignments and differences between two sentences according to one or more embodiments of the present invention. The alignments and the differences can be computed by an appropriate algorithm such as Needleman-Wunsch algorithm.

By using the appropriate algorithm, given two term sequences (or a character sequence in other embodiment), a cost table of edit distance such as Levenshtein distance are computed as shown in FIG. 4. In FIG. 4, two term sequences are arranged in rows and columns and each cell represents a cost. A solid arrow indicates an inverted path from each cell to the cell achieving its optimal cost whereas a dotted arrow indicates an inverted path from each cell to the cell not achieving its optimal cost.

Given two term sequences, the cost table of Levenshtein distance shown in FIG. 4 is computed. During the computation of the cost for each cell based on the algorithm, the previous cells achieving the optimal cost of the cell and operations: insert (from the left cell), delete (from the upper cell) or matching (from the left upper cell) are stored. A path from its end to its start may be determined by starting from the right-most, lower-most cell and repeatedly choosing one of the previous cell defined above. The terms in the first sentence the previous operation for whose cell is deletion are marked as deleted terms. The terms in the second sentence the previous operation for whose cell is insertion are marked as inserted terms.

In FIG. 4, the optimal cost of cell (‘mayor’, ‘mayor’) is achieved by a matching operation from the left upper cell. The cell (‘by’, ‘ratio’) has two previous cells to achieve its optimal cost: insertion from its left or deletion from its upper cell.

In a particular embodiment, the cost for insertion and deletion can be set to a fixed value. However, in a preferable embodiment, the cost for insertion and deletion can be set according to a word or its position (e.g., the frequency of the word). The replacement cost can be set according to a pair of words and it can be replaced by insertion and deletion operation after the path is determined. If there are more than one candidates of previous cells, the one with the same operation as the previous operation is prioritized, which makes the alignment having more successive terms of insertion or deletion.

For instance, if there are two sentences ‘tax rate specified by the mayor’ and ‘tax ratio the mayor specified’, there may be two possible alignment candidates ‘tax [rate specified by] (ratio) the mayor (specified)’ and ‘tax [rate] (ratio) [specified by] the mayor (specified)’ where the brackets [ ] represent deletion operations and parentheses ( ) represent insertion operations. In this example, the first alignment candidates ‘tax [rate specified by] (ratio) the mayor (specified)’ would be prioritized since the first candidate has longer successive terms of deletions [rate specified by] in comparison with the second candidates having deletions [rate] and [specified by].

Furthermore, in a particular embodiment, the alignment and the difference may be computed by further storing optimal and suboptimal alignment candidates for each similar text; and choosing a combination of alignments having the same operations (the same insertion operations or the same deletion operations) in succession as long as possible. For instance, when given two sentence ‘A B of C’ and ‘A D of E’ where each of A, B, C and D represents one or more certain words, the cost of the alignment candidate ‘A [B](D) of [C](E)’ may smaller than the cost of the alignment candidate ‘A [B of C](D of E)’. Hence, the alignment candidate ‘A [B of C](D of E)’ is suboptimal. However, the alignment ‘A [B of C](D of E)’ could be chosen since the text blocks ‘B of C’ and ‘D of E’ is more likely to a phrase.

Referring back to FIG. 2, at step S104, the processing unit may count the occurrence of the string of each difference (the deletion parts and the insertion parts) in the target text to a queue.

By performing the processing from step S101 through step S104, a difference summary between the target text and the set of similar texts is prepared.

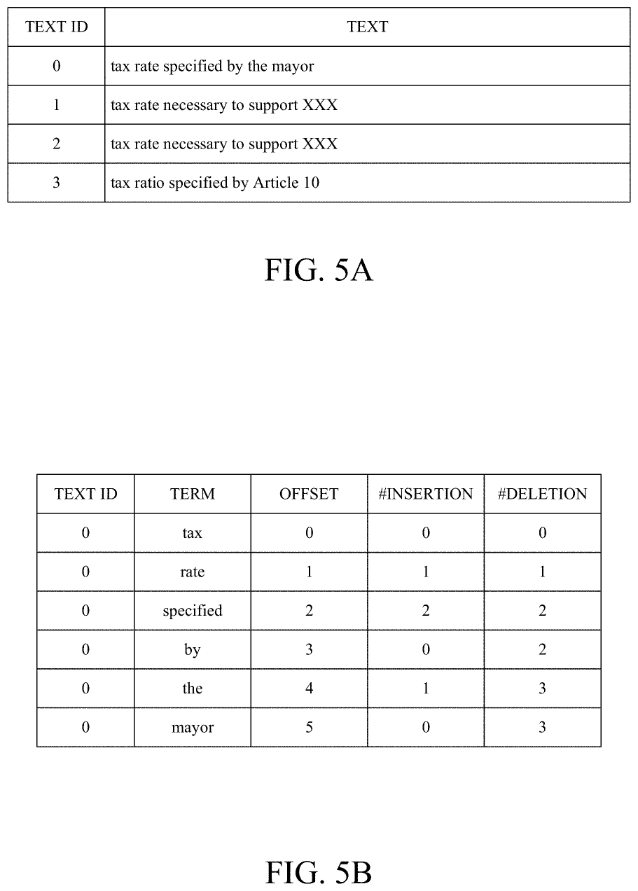

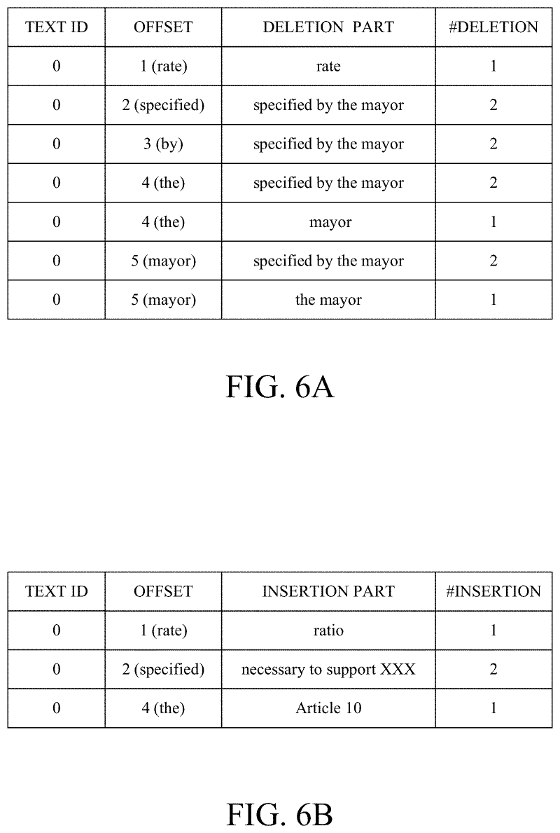

FIGS. 5A-5B and FIGS. 6A-6B show a schematic of data structures storing the difference summary according to an exemplary embodiment of the present invention. FIG. 5A illustrates data structure of original target and similar texts. The original data structure may include a text identifier (TEXT ID) column and a content text (TEXT) column. The original data structure may be converted into the set of data structures shown in FIG. 5B, FIG. 6A and FIG. 6B.

The sentence of the target text is converted into a term sequence with an offset value associated with each term as shown in FIG. 5B. The offset value indicates a term position in the text from the head (the offset is 0). Each term has the number of deletions (i.e., the deletion frequency) and the number of the insertion (i.e. the insertion frequency). In a particular embodiment, the number of deletions may determine the color depth of the background color of the corresponding term. The number of insertions may determine a number and/or a symbol inserted at the boundary related to the corresponding term (more specifically, a beginning of the corresponding term).

FIG. 6A is a converted data structure containing deletion details. The data structure shown in FIG. 6A includes the offset position, the deletion part and the number of the deletions. FIG. 6B is a converted data structure containing insertion details. The data structure shown in FIG. 6B includes the offset position, the insertion part and the number of the insertions.

These fields in the aforementioned structures show how frequently and to which expressions each term is replaced, for visualization. The data structures shown in FIG. 5B, FIG. 6A and FIG. 6B include information that is aggregated from the set of similar texts and would provide the difference summary including one or more variable text parts in the target text (consecutive terms each having the number of deletions >0, a boundary designated by an offset having the number of insertions >0 in FIG. 5B and the deletion part in FIG. 6A); a statistic of varying of each variable text part over the set of similar texts (the number of deletions and the number of insertions in FIG. 5B); an individual deletion frequency of each deletion part over the set of similar texts (the number of deletions of the particular deletion part in FIG. 6A); and a set of insertion parts (the insertion part in FIG. 6B) for each insertion position and an usage frequency of each insertion part over the set of similar texts (the number of insertions of the particular insertion part in FIG. 6B).

Referring back to FIG. 2, at step S105, the processing unit may mark a text range (designated by start and end offset) related to one or more deletion parts in the target text in a first manner (e.g., by a background color depth) based on a deletion frequency of the one or more deletion parts related to the text range. At step S106, the processing unit may mark a boundary at the insertion position in the target text in a second manner (e.g., inserting a number with brackets) based on the insertion frequency relating to the insertion position. At step S107, the processing unit may show the target text with the variable text parts marked and then the process may end at step S108.

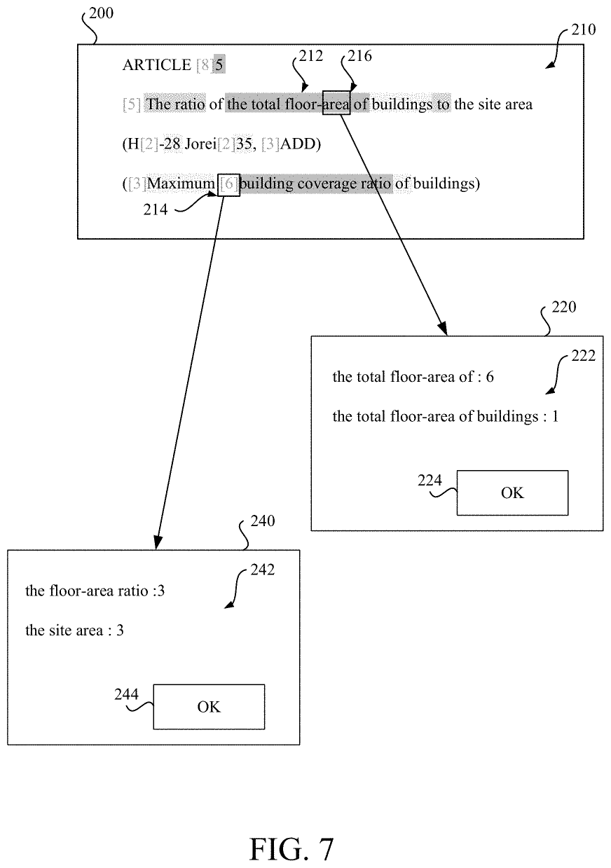

FIG. 7 depicts graphical user interfaces for presenting a target text with summary information of deletions and insertions according to an exemplary embodiment of the present invention. The text box 200 illustrated in FIG. 7 shows contents of the target text 210 with markings 212, 214. In the text box 200, a plurality of text ranges 212 (In FIG. 7, only one text range is associated with the numeric ‘212’ as a representative) are highlighted by a background color depth. The depth of the background color of a certain text range 212 indicates the deletion frequency or the number of deletion parts involving the text range 212. As the frequency or the number increases, the color depth becomes darker. The depth of the background color of the text ranges 212 in FIG. 7 indicates that the text block ‘the total floor-area of’ is more frequently deleted than the block ‘the total floor-area of buildings’.

Furthermore, in the text box 200, a notation 214 having a numeric character with square brackets (e.g., [6]) is inserted into each of several word boundaries (In FIG. 7, only one boundary is associated with the numeric ‘214’ as a representative). The numeric notation 214 indicates there is at least one insertion in a similar text at the boundary corresponding to the position of the notation 214 in the target text and the number of similar texts having insertion at the position.

The text box 200 is configured to show additional dialog boxes in response to choosing a term 216 highlighted or a term boundary having the numeric notation 214.

FIG. 3A shows a flowchart of process for presenting a deletion summary performed in response to choosing a highlighted term 216. The process shown in FIG. 3A may begin at step S200 in response to choosing the highlighted term 216 in the text box 200. At step S201, the processing unit may obtain a list of deletion parts each containing the chosen term with their deletion frequencies of listed deletion parts. At step S202, the processing unit may display the list of deletion parts containing the term with the deletion frequency of each deletion part.

The dialog box 220 in FIG. 7 depicts a graphical user interface for presenting the deletion summary. As shown in FIG. 7, the dialog box 220 has a message 222 indicating the list of deletion parts containing the chosen term with respective deletion frequencies and an OK button 224 for receiving an instruction to close the dialog box 220.

At step S203, the processing unit may determine whether the popup dialog box is instructed to close or not. If there is no instruction yet (NO) in the step S203, the process may loop in the step S203. If the popup dialog box is instructed to close (YES) in the step S203, the process may proceed to step S204 and the process may end at step S204.

FIG. 3B shows a flowchart of process for presenting an insertion summary performed in response to choosing a term boundary having the numeric notation 214. The process shown in FIG. 3B may begin at step S300 in response to choosing the numeric notation 214 in the text box 200. At step S301, the processing unit may obtain a list of insertion parts related to the boundary with their insertion frequencies. At step S302, the processing unit may display the list of insertion parts with the insertion frequencies of each insertion part.

The dialog box 240 in FIG. 7 depicts a graphical user interface for presenting the insertion summary. As shown in FIG. 7, the dialog box 240 has a message 242 indicating the list of insertion parts relating to the chosen boundary with respective insertion frequencies and an OK button 244 for receiving an instruction to close the dialog box 240.

At step S303, the processing unit may determine whether the popup dialog box is instructed to close or not. If there is no instruction yet (NO) in the step S303, the process may loop in the step S303. If the popup dialog box is instructed to close (YES) in the step S303, the process may proceed to step S304 and the process may end at step S304.

As described above, the technique according to the exemplary embodiments of the present invention helps us to understand what expressions are replaced in other similar text, what expressions are used instead in other similar texts and how often these replacements occur, by presenting the summary information including the statistic that is aggregated from the set of similar texts.

Since merely the summary information aggregated from the set of similar texts is presented instead of individual deletion and insertion text parts, readability of the original target text is maintained while the summary information presented by the marking provides the statistic information of deletion and addition.

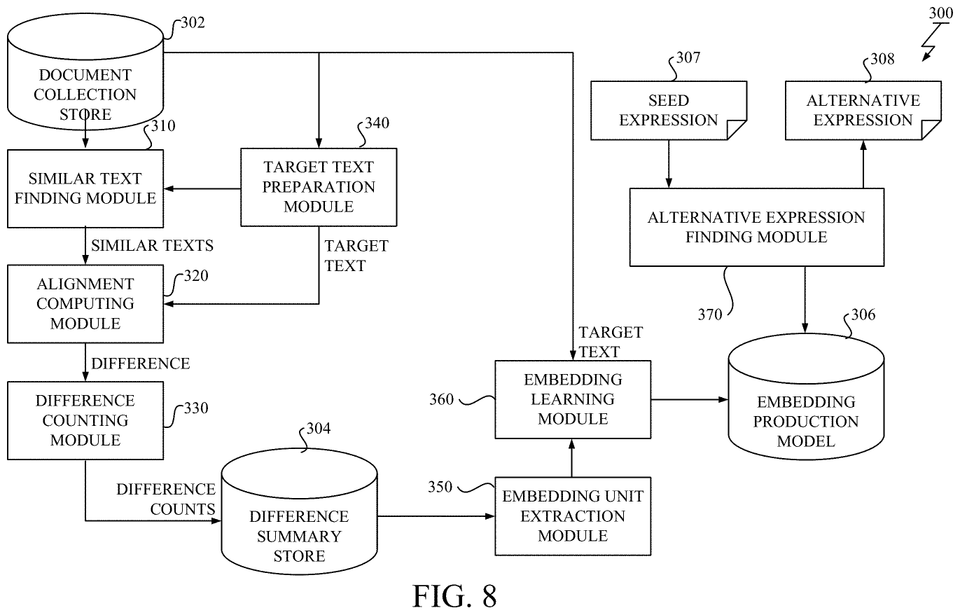

In the aforementioned embodiments, the difference summary is utilized for presenting a document with difference summary including the statistic that is aggregated from the set of similar texts. However, in other embodiment, the computed difference summary may be utilized for text mining such as finding of alternative expressions (i.e., 308) or variations for a seed expression (i.e., 307). Herein below, referring to a series of FIG. 8 through FIG. 11, a computer-implemented method, a computer system and a computer program product for mining a frequently occurring expression in a text written in a natural language according to an exemplary embodiment will be described.

With reference to FIG. 8, a schematic of a text mining system according to an exemplary embodiment of the present invention is described. As shown in FIG. 8, the text mining system 300 may include a document collection store 302, a similar text finding module 310, an alignment computing module 320; a difference counting module 330, a difference summary store 304, and a target text preparation module 340. These modules shown in FIG. 8 have common or similar functionality to one that has the same name shown in FIG. 1, unless otherwise noted.

The document collection store 302 is configured to store a collection of documents as similar to the embodiment shown in FIG. 1. The target text preparation module 340 is configured to prepare, obtain, acquire or get a target text of the document in a text collection stored in the document collection store 302.

The similar text finding module 310 is configured to find a plurality of texts similar to the target text from the text collection stored in the document collection store 302, as a set of similar texts. The alignment computing module 320 is configured to compute an alignment and a difference between the target text and each similar text in the set of similar texts by calculating a cost of modifying between the target text and each similar text by deletion and/or insertion operations. Once the alignment is taken, a difference between the target text and each similar text may be computed as a deletion part or an insertion part.

Note that similarity and alignment can be calculated between the target text and each similar text at a variety of levels, including a document, a chapter level, section level, a sentence level, an article level, etc., by using an appropriate natural language processing technique.

The difference counting module 330 is configured to count the occurrence of the string of each difference in the target text. The difference includes the deletion part. The difference counting module 130 is configured to obtain a statistic of each difference over the text collection. In the described embodiment, merely the deletion part is counted for computing the statistic.

By repeatedly performing the processes of the modules 310, 320, 330 340 for each text picked up from the text collection stored in document collection store 302, the difference summary between paired arbitrary similar texts in the text collection is prepared and accumulated in the difference summary store 304. As described above, in the described embodiment, merely the deletion part is counted for computing the statistic. However, in other embodiment, the insertion part can also be counted for computing the statistic. By counting the insertion part, the number of comparisons required to complete the calculation for any arbitrary pair of similar text is expected to be reduced.

As shown in FIG. 8, the text mining system 300 may further include an embedding unit extraction module 350, an embedding learning module 360, an embedding production model 306 and an alternative expression finding module 370.

The embedding unit extraction module 350 is configured to enumerate a plurality of variable text parts as a set of embedding units based on the statistic of each difference. More specifically, in the described embodiment, the occurrence of each deletion part is counted and the plurality of variable text parts may be extracted according to the deletion frequency of each deletion part.

In a particular embodiment, the embedding unit extraction module 350 may extract top-N frequent variable text parts as the embedding units. In other particular embodiment, the embedding unit extraction module 350 may extract a variable text part having a frequency above a predetermined threshold as the embedding unit. In further other particular embodiment, the variable text part having longer length of the words or characters may be prioritized. This is because longer words generally are less likely or rarer to occur than shorter words.

The embedding learning module 360 is configured to learn an embedding production model 306 by using the extracted variable text parts (frequently-deleted parts). The embedding learning module 360 may tokenize an example text into a sequence of linguistic units. In the described embodiment, the word is the linguistic unit used to compose the sequence. However in another embodiment, the linguistic unit is a character and the character sequence may also be contemplated. The embedding learning module 360 may replace an instance of each embedding unit (e.g., phrase X) that appears in the term sequence with a pseudo-word representing a corresponding one of the embedding units (e.g., a specifically-defined pseudo-word to represent the phrase X). Then, the embedding learning module 360 may learn the embedding production model 306 by using the term sequence replaced.

In a particular embodiment, the embedding production model 306 may be configured to output, in response to an input, a vector representing the input. In a particular embodiment, the embedding production model 306 is a word2vec model. In one embodiment, learning of the embedding learning module 360 may be performed from a scratch. In other embodiment, learning of the embedding learning module 360 may be performed from a starting point that has been pretrained by using more general corpus. Once the word2vec model is trained, the word2vec model can detect synonymous words or phrases.

The alternative expression finding module 370 is configured to receive a seed expression 307, find one or more alternative expressions 308 or variations for the seed expression 307 by using the embedding production model 306 and output the alternative expressions 308 or variations. The alternative expressions 308 or variations can be extracted by approximated nearest neighbor search with a vector of the seed expression 307 by using the embedding production model 306, for instance.

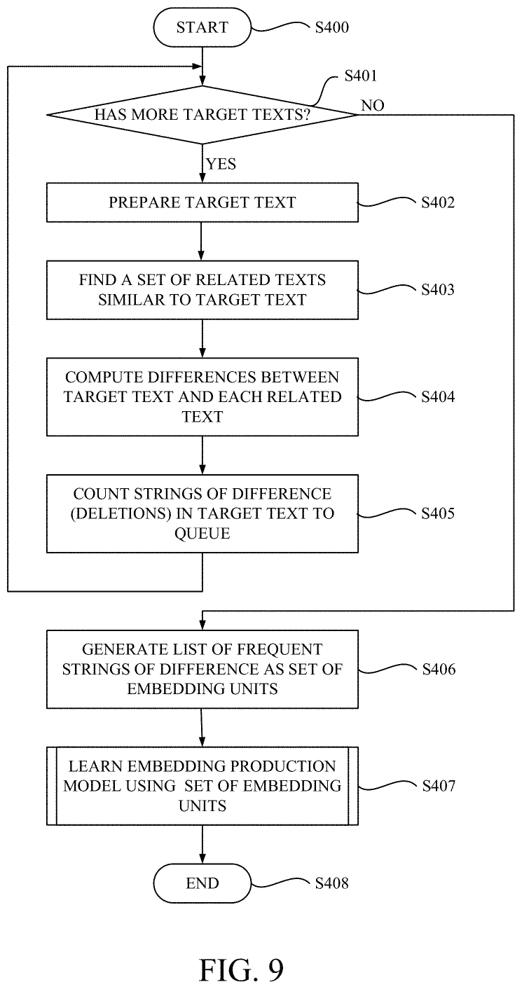

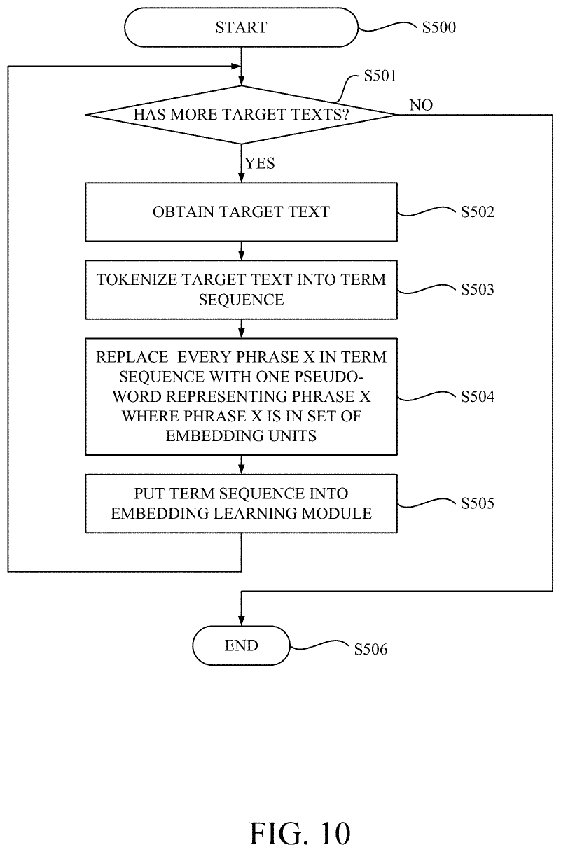

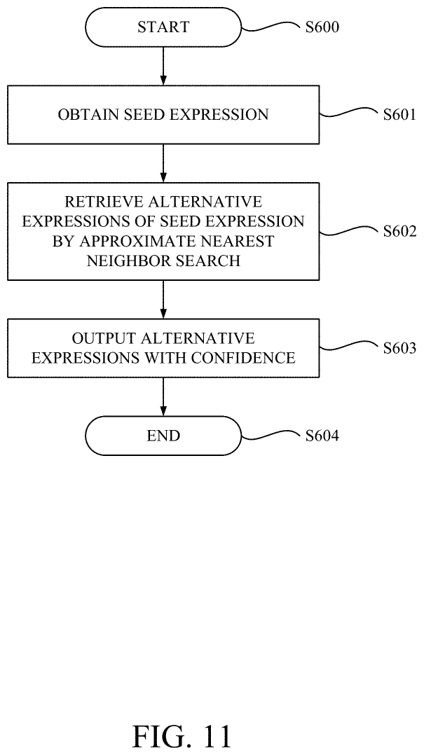

Hereinafter, with reference to FIG. 9 to FIG. 11, a process for text mining according to an exemplary embodiment of the present invention is described. FIG. 9 shows a flowchart of a process for text mining to extract variable text parts. FIG. 10 shows a flowchart of a sub-process for text mining to extract variable text parts. FIG. 11 shows a flowchart of a process for obtaining alternative expressions 308 for a seed expression 307 by using learned model. Note that the processes shown in FIG. 9 to FIG. 11 may be performed by processing circuitry such as a processing unit of a computer system that implements at least one of aforementioned modules.

The process shown in FIG. 9 may begin at step S400 in response to receiving a request for text mining from an operator, for instance. However, the process may begin in response to any event, including a trigger event, an implicit request, a timer, etc.

At step S401, the processing unit may determine whether a target text to be processed remains or not. If it is determined that at least one target text to be processed remains (YES) in the step S401, the process may proceed to step S402. At step S402, the processing unit may prepare one text from the text collection stored in the document collection store 302, as a target text. At step S403, the processing unit may find a plurality of texts similar to the target text from the text collection as a set of similar texts. At step S404, the processing unit may compute an alignment and a difference between the target text and each similar text in the set of similar texts. At step S405, the processing unit may count the occurrence of the string of each difference (the deletion parts) in the target text to a queue and then the process may loop back to the step S401. If no target text to be processed remains (NO) in the step S401, the process may proceed to step S406.

By performing the step 401 through the step 405, the statistic of the string that appears in the difference between the paired similar texts in the text collection is accumulated in the difference summary store 304. At step S406, the processing unit may generate a list of frequent strings of difference as a set of embedding units based on the statistic information accumulated in the difference summary store 304.

At step S407, the processing unit may learn an embedding production model 306 using the set of embedding units extracted at step S406 and the process may end at step S408.

The process shown in FIG. 10 may begin at step S500 in response to the process of step 407 being performed.

At step S501, the processing unit may determine whether a target text to be processed remains or not. If it is determined that a target text to be processed remains (YES) in the step S501, the process may proceed to step S502. At step S502, the processing unit may obtain a target text from the text collection stored in the document collection store 302. At step S503, the processing unit may tokenize the target text into a term sequence. At step S504, the processing unit may replace an instance of each embedding unit in the term sequence with a pseudo-word representing a corresponding embedding unit.

At step S505, the processing unit may put the term sequence whose instance of embedding unit is replaced with the pseudo-word to the embedding learning module 360 in order to learn the embedding production model 306 and then the process may loop back to the step S501. If no target text to be processed remains (NO) in the step S501, the process may proceed to step S506 and the process may end at step S506.

The process shown in FIG. 11 may begin at step S600 (ending at step S604) in response to receiving a request for finding alternative expressions for a designated seed expression, for instance. A consecutive words (e.g., ‘by the mayor’) are designated as the seed expression. At step S601, the processing unit may receive the designated seed expression. At step S602, the processing unit may retrieve alternative expressions for the seed expression by approximate nearest neighbor search to the embedding production model 306. At step S603, the processing unit may output alternative expressions (e.g., ‘by the chairperson’, ‘by the town mayor’, . . . ) with their confidence values. The confidence value may be any metric measuring the similarity between the expressions, which includes cosine similarity between the vectors of the seed expression and the alternative expression.

Hereinafter, the advantages of the system and process for mining a frequently occurring expression in a text written in a natural language according to one or more embodiment of the present invention will be described by referring to experimental results.

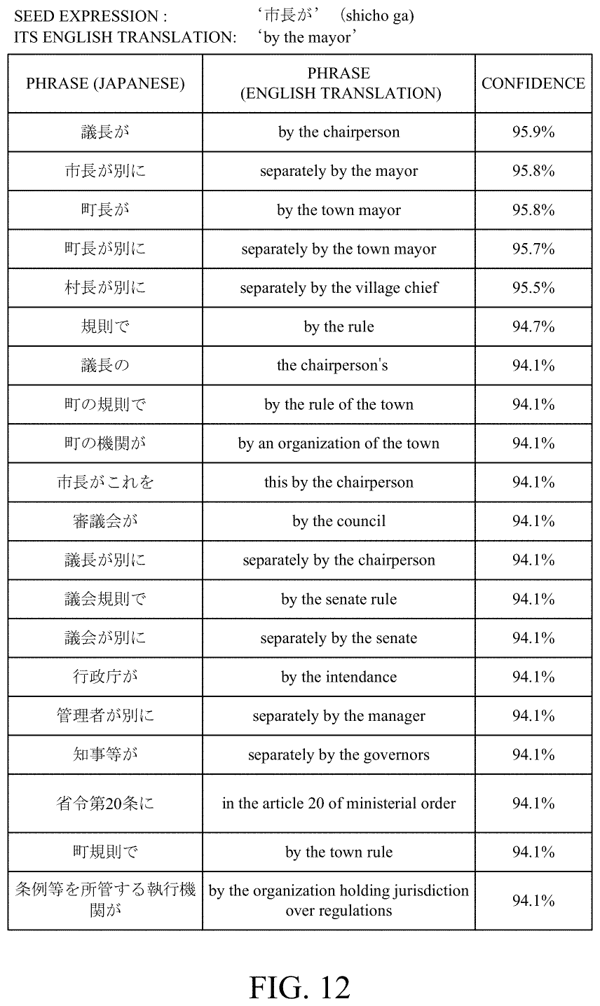

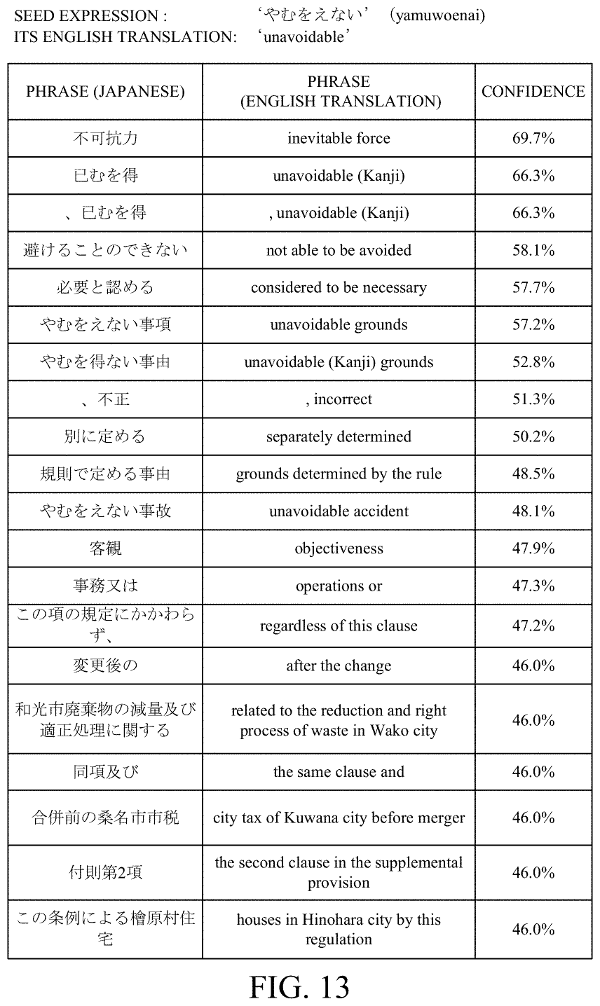

FIG. 12 and FIG. 13 show results of finding alternative expressions for specific seed expressions by using an existing database. The profile of “Jourei web” data (http://www.jourei.net/) which includes a volume of 14 k documents of regulations of local governments in Japan was utilized. The category information including the top categories (themes such as tac welfare, etc.) and sub-categories (implicitly having a regulation type such as city planning tax, personal information protection, etc.) were not used. The similarity search for finding the similar text was based on the name of a regulation and its content.

FIG. 12 shows a result of finding alternative expressions for a seed expression’ shicho ga (its translation is ‘by the mayor’). FIG. 13 shows a result of finding alternative expressions for a seed expression ‘yamuwoenai (its translation is ‘unavoidable’). As shown in FIG. 12 and FIG. 13, the similarity search based on the method according to the exemplary embodiment of the present invention successfully retrieved related phrases for the sample queries of ‘shichoga’ and ‘yamuwoenai’, including long expressions.

According to the aforementioned embodiments, there is provided a method, a computer system and a computer program product capable of extracting a text part that are easily replaced, as a frequently-occurring expression, which helps natural language processing.

The embedding production model trained by using the difference summary aggregated from the text collection enables the system to retrieve the alternative expressions having the same context as that of the original expression in the target text even if it is difficult to identify the semantic similarity between the original expression and alternative expression.

Note that the languages to which the novel technique according to the embodiments of the invention is applicable is not limited and examples of such the languages may include, by no means limited to, Arabic, Chinese, English, French, German, Japanese, Korean, Portuguese, Russian, Swedish, Spanish, for instance.

Although the advantages obtained with respect to the one or more specific embodiments according to the present invention have been described, it should be understood that some embodiments may not have these potential advantages, and these potential advantages are not necessarily required of all embodiments.

Computer Hardware Component

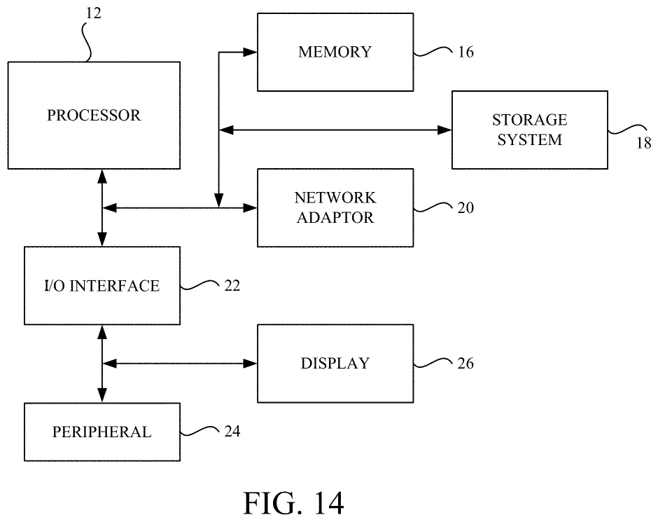

Referring now to FIG. 14, a schematic of an example of a computer system 10, which can be used for the document presentation system 100 and the text mining system 300, is shown. The computer system 10 shown in FIG. 14 is implemented as computer system. The computer system 10 is only one example of a suitable processing device and is not intended to suggest any limitation as to the scope of use or functionality of embodiments of the invention described herein. Regardless, the computer system 10 is capable of being implemented and/or performing any of the functionality set forth hereinabove.

The computer system 10 is operational with numerous other general purpose or special purpose computing system environments or configurations. Examples of well-known computing systems, environments, and/or configurations that may be suitable for use with the computer system 10 include, but are not limited to, personal computer systems, server computer systems, thin clients, thick clients, hand-held or laptop devices, in-vehicle devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 10 may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 14, the computer system 10 is shown in the form of a general-purpose computing device. The components of the computer system 10 may include, but are not limited to, a processor (or processing unit) 12 and a memory 16 coupled to the processor 12 by a bus including a memory bus or memory controller, and a processor or local bus using any of a variety of bus architectures.

The computer system 10 typically includes a variety of computer system readable media. Such media may be any available media that is accessible by the computer system 10, and it includes both volatile and non-volatile media, removable and non-removable media.

The memory 16 can include computer system readable media in the form of volatile memory, such as random access memory (RAM). The computer system 10 may further include other removable/non-removable, volatile/non-volatile computer system storage media. By way of example only, the storage system 18 can be provided for reading from and writing to a non-removable, non-volatile magnetic media. As will be further depicted and described below, the storage system 18 may include at least one program product having a set (e.g., at least one) of program modules that are configured to carry out the functions of embodiments of the invention.

Program/utility, having a set (at least one) of program modules, may be stored in the storage system 18 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

The computer system 10 may also communicate with one or more peripherals 24 such as a keyboard, a pointing device, a car navigation system, an audio system, etc.; a display 26; one or more devices that enable a user to interact with the computer system 10; and/or any devices (e.g., network card, modem, etc.) that enable the computer system 10 to communicate with one or more other computing devices. Such communication can occur via Input/Output (I/O) interfaces 22. Still yet, the computer system 10 can communicate with one or more networks such as a local area network (LAN), a general wide area network (WAN), and/or a public network (e.g., the Internet) via the network adapter 20. As depicted, the network adapter 20 communicates with the other components of the computer system 10 via bus. It should be understood that although not shown, other hardware and/or software components could be used in conjunction with the computer system 10. Examples, include, but are not limited to: microcode, device drivers, redundant processing units, external disk drive arrays, RAID systems, tape drives, and data archival storage systems, etc.

Computer Program Implementation

The present invention may be a computer system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, steps, layers, elements, and/or components, but do not preclude the presence or addition of one or more other features, steps, layers, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for presenting and/or showing a text, comprising:
obtaining a target text;
preparing a difference summary between the target text and a set of similar texts similar to the target text, the difference summary comprising one or more variable text parts in the target text each varied in at least one text in the set of similar texts and a statistic of varying of each variable text part over the set of similar texts;
marking the one or more variable text parts in the target text based on the statistic of each variable text part; and
showing the target text with the one or more variable text parts marked.

2. The computer-implemented method of claim 1, wherein the difference summary is computed by:
finding a plurality of texts similar to the target text as the set of similar texts;
computing an alignment and a difference between the target text and each similar text in the set of similar texts by calculating a cost of modifying between the target text and each similar text by deletion and/or insertion; and
counting occurrence of string of each difference in the target text over the set of similar texts.

3. The computer-implemented method of claim 2, wherein modifying between the target text and each similar text does not take replacement operation into account.

4. The computer-implemented method of claim 2, wherein the difference summary is computed by further:
storing optimal and suboptimal alignment candidates for each similar text; and
choosing a combination of alignments having the same operations in succession as long as possible.

5. The computer-implemented method of claim 1, wherein the one or more variable text parts comprise a deletion part and an insertion position, the statistic of varying of each variable text part includes a deletion frequency or an insertion frequency.

6. The computer-implemented method of claim 5, wherein marking the one or more variable text parts in the target text comprise:
marking a text range related to one or more deletion parts in the target text in a first manner based on a deletion frequency of the one or more deletion parts; and
marking a boundary at the insertion position in the target text in a second manner different from the first manner based on an insertion frequency relating to the insertion position.

7. The computer-implemented method of claim 1, wherein the one or more variable text parts comprise a deletion part, the statistic of varying of each variable text part includes a deletion frequency of the deletion part and the method further comprises:
in response to choosing a term in the target text, showing one or more deletion parts containing the term with the deletion frequency of each of the one or more deletion parts.

8. The computer-implemented method of claim 1, wherein the one or more variable text parts comprise an insertion position, the statistic of varying of each variable text part includes an insertion frequency relating to the insertion position and the method further comprises:
in response to choosing a boundary in the target text, showing a detail of an insertion related to an insertion position at the boundary.

9. The computer-implemented method of claim 8, wherein the difference summary further includes one or more insertion parts, for each insertion position, included in at least one text in the set of similar texts and a usage frequency of each insertion part over the set of similar texts, and showing the detail comprises:
showing the one or more insertion parts related to the boundary with the usage frequency of each of the one or more insertion parts.

10. A computer system for showing and/or selecting a text, the computer system comprising:
a processor; and
a memory coupled to the processor, the processor being configured to:
obtain a target text;
prepare a difference summary between the target text and a set of similar texts similar to the target text, wherein the difference summary comprises one or more variable text parts in the target text each varied in at least one text in the set of similar texts and a statistic of varying of each variable text part over the set of similar texts;
mark the one or more variable text parts in the target text based on the statistic of each variable text part; and
show the target text with the one or more variable text parts marked.

11. The computer system of claim 10, wherein the difference summary is computed by:
finding a plurality of texts similar to the target text as the set of similar texts;
computing an alignment and a difference between the target text and each similar text in the set of similar texts by calculating a cost of modifying between the target text and each similar text by deletion and/or insertion; and
counting occurrence of string of each difference in the target text.

12. The computer system of claim 10, wherein the one or more variable text parts comprise a deletion part and an insertion position, the statistic of varying of each variable text part includes a deletion frequency or an insertion frequency, and marking the one or more variable text parts in the target text comprise:
marking a text range related to one or more deletion parts in the target text in a first manner based on a deletion frequency of the one or more deletion parts; and
marking a boundary at the insertion position in the target text in a second manner different from the first manner based on the insertion frequency relating to the insertion position.

13. A computer program product for presenting and/or showing a text, the computer program product comprising a computer readable storage medium having program instructions embodied therewith, wherein the program instructions executable by a computer to cause the computer to perform a method comprising:
obtain a target text;
prepare a difference summary between the target text and a set of similar texts similar to the target text, the difference summary comprising one or more variable text parts in the target text each varied in at least one text in the set of similar texts and a statistic of varying of each variable text part over the set of similar texts;
mark the one or more variable text parts in the target text based on the statistic of each variable text part; and
show the target text with the one or more variable text parts marked.

14. The computer program product of claim 13, wherein the difference summary is computed by:
find a plurality of texts similar to the target text as the set of similar texts;
compute an alignment and a difference between the target text and each similar text in the set of similar texts by calculating a cost of modifying between the target text and each similar text by deletion and/or insertion; and
count occurrence of string of each difference in the target text over the set of similar texts.

15. The computer program product of claim 14, wherein modifying between the target text and each similar text does not take replacement operation into account.

16. The computer program product of claim 14, wherein the difference summary is computed by further:
store optimal and suboptimal alignment candidates for each similar text; and
choose a combination of alignments having the same operations in succession as long as possible.

17. The computer program product of claim 13, wherein the one or more variable text parts comprise a deletion part and an insertion position, the statistic of varying of each variable text part includes a deletion frequency or an insertion frequency.

18. The computer program product of claim 17, wherein mark the one or more variable text parts in the target text comprise:
mark a text range related to one or more deletion parts in the target text in a first manner based on a deletion frequency of the one or more deletion parts; and
mark a boundary at the insertion position in the target text in a second manner different from the first manner based on an insertion frequency relating to the insertion position.

19. The computer program product of claim 13, wherein the one or more variable text parts comprise a deletion part, the statistic of varying of each variable text part includes a deletion frequency of the deletion part and the method further comprises:
in response to choosing a term in the target text, show one or more deletion parts containing the term with the deletion frequency of each of the one or more deletion parts.

20. The computer program product of claim 13, wherein the one or more variable text parts comprise an insertion position, the statistic of varying of each variable text part includes an insertion frequency relating to the insertion position and the method further comprises:
in response to choosing a boundary in the target text, show a detail of an insertion related to an insertion position at the boundary.
